(19) United States
(12) Patent Application Publication
(10) Pub. No.: US 2005/0119943 A1
(43) Pub. Date: Jun. 2, 2005

(54) Method and system for receiver self-priced multimedia communication over the internet and a member pool

(76) Inventor: Kuo-Chun Fang, Taipei (TW)

Correspondence Address: GRAFFITI PROMOTIONS, LLC, 827 WINDSOR ROAD, ARNOLD, MD, 21012, US

(21) Appl. No.: 10/831,857

(22) Filed: Apr. 26, 2004

Related U.S. Application Data
(60) Provisional application No. 60/481,678, filed on Nov. 20, 2003.

(30) Foreign Application Priority Data
Dec. 1, 2003 (TW) 092132211
Dec. 12, 2003 (TW) 2003/101225324

(51) Int. Cl. G06F 17/60

(52) U.S. Cl. 705/26

(57) ABSTRACT

The present invention accomplishes billing and collection of multimedia IP calls with Receiver designated fee schemes, enabling advance services such as personal 800 or 900 service in the conventional telephony. Internet users register as members via member sub-system, and acquire a unique member ID across the member pool by downloading and installing client-software, and login to the communication sub-system and enter a “stand-by for communication” mode. Member chooses a fee flow method among options of “Pay-to-Answer(PA)”, “Charge-to-Answer(CA)” , and “Free-to-Answer(FA)”, and set member's own per-pulse fee rate. Depending on members chosen fee scheme, in case of a CA member, call can be answered without having to deposit stored value into members fee account, because fee will flow from caller to receiver, and benefit the receiving member. In case of a PA or FA fee flow methods, the receiving member will have to purchase via transaction sub-system and deposit into the stored-value fee account, in order to fulfill the fee flow paying to the caller and system. Depending on the Called (receiving) member's chosen fee scheme, in case of a PA or FA call, calling member can be cleared for the call, because the calling party will benefit from the call and there is no need for the caller to pay any fee. In case of a CA call, the calling member will have to purchase via transaction sub-system and deposit into the stored-value fee account, in order to fulfill the fee flow paying to the called (receiving) member and system.

### CROSS REFERENCE TO RELATED APPLICATIONS:

This application claims priority from U.S. Provisional Patent Application Ser. No. 60/481,678, entitled Method and System for Receiver Self-priced Multimedia Communication Over the Internet and a Member Pool, filed on Nov. 20, 2003.

This application cross-references Taiwan Patent Application SN 092132211, entitled Method and System for Receiver Self-priced Multimedia Communication Over the Internet and a Member Pool, filed on Dec. 1, 2003.

This application cross-references China Patent Application SN 2003/101225324, entitled Method and system for multimedia communication over the Internet and a member pool, filed on Dec. 12, 2003.

### SEQUENCE LISTING OR PROGRAM

Not Applicable

### FEDERALLY SPONSORED RESEARCH

Not Applicable

### TECHNICAL FIELD OF THE INVENTION

This invention relates to multimedia communications over the Internet, and more specifically relates to a receiver self-priced fee scheme for the determination of fee flow and the billing and collection of fees between the caller and receiver.

### BACKGROUND OF THE INVENTION

For return on investment (ROI) concerns, traditional telephone companies bill and collect telephone charges from their subscribers under one of these well known schemes: Caller pay, Receiver pay, and Both Caller and Receiver pay. Telephone companies will design various rate plans for customers to subscribe, these rate plans are usually regulated and subject to the approval of regulatory bodies, and are integral parts of service contracts between telephone companies and subscribers.

Among all the telephony products and rate plans, Premium Rate Services (PRS) have evolved since the early 80's, whilst telephone companies engage third party service provider to provide value-added service via the telephone infrastructure, callers will have to pay a premium rate to gain access to these services. The receiver (provider) of a PRS call is the only party that is granted the contractual right to share the telephone charges that telephone companies collect from subscribers.

It is also normal to see that rate plans are not always call related, therefore basic service charges are common, meaning some price is to be paid for being just “connected” regardless of whether calls are made of not. In recent years, flat monthly fee plans are gaining popularity, while subscribers pay a flat fee and can make as many calls as he/she please without incurring additional per-call charges.

The latest evolution of communications over IP has enabled point-to-point as well as pooled multimedia communications without relying on the switch systems built by telephone companies for the call routing and exchange, and therefore also detached such communications from the billing and collection systems that the telephone companies built over their subscriber bases. The IP network builders need to take different approaches to address the needs to price and collect fees to make the facilitating of communications over IP networks a viable business.

As observed in the marketplace, IP network builders or providers were still limited to the convention wisdoms of the old telephony industry. Users are given very no choice to leverage on their knowledge base to transform the perceived value in multimedia enhanced IP communications into financial benefit, not to mention the opportunity to participate in an open market for the acquisition of useful digital contents from sources that price their contents in a competitive fashion.

### SUMMARY OF THE INVENTION

The present invention accomplishes billing and collection of multimedia IP calls with Receiver designated fee schemes, and thereby enables such advance services as personal 800 or 900 service in the conventional telephony. Moreover, what goes beyond the telephony conventions is that with “Pay-to-Answer” option, the receiver can add virtually limitless incentives into the terms to attract other members to make that call.

People involved in any communications (e.g. Instant Messaging over the internet) incur opportunity cost of the “time” and “perceived value of content”. The method and system empowers any member being called (as a receiver) to monetize these opportunity costs and realize financial benefits derived from the communication session. The present invention addresses the above stated needs by providing a capability to perform Receiver Self-priced multimedia communications via the IP network and over a member pool.

The Receiver Self-priced scheme allows a registered member to apply a pre-determined fee scheme comprising “fee flow” and “per-pulse rate” parameters in answering a call via an Internet connected device with installed client software. Depending on the receiver's designated fee flow, one of the parties involved in the communication will benefit from the transfer of monetary values of tokens, in an amount calculated in accordance with the receiver designated per-pulse rate.

Adopting the open market principle, members are free to choose an applicable fee flow with three options when members answer calls, namely “Pay-to-Answer”, “Free-to-Answer” and “Charge-to-Answer”. The options members chose will place the member in the marketplace as either a “Buyer”, “Neutral Player” or “Seller”. When a call is placed and answered, the main service contract is established between the caller and receiver, and fees are calculated and transferred between members, while the system servers as an intermediary, and collect a part of the fee flow as the reward with the nature being a commission.

### BRIEF DESCRIPTION OF THE DRAWINGS

FIG. 1 illustrates the system diagram of the present invention;

FIG. 2 illustrates the workflow process of member sub-system of the present invention;

FIG. 3 illustrates the workflow process of the communication sub-system of the present invention;

FIG. 4 illustrates the workflow process of the clearing sub-system of the present invention;

FIG. 5 illustrates the simplified workflow process of the transaction sub-system of the present invention;

FIG. 6 illustrates a call scenario and fee flow example of the present invention.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

Referring to the figures, it is possible to see the various major elements constituting the apparatus of the present invention. The invention is a method and process for enabling multimedia communications over a multi-user electronic network such as the Internet, which incorporates a receiver self-priced fee scheme for the determination of fee flow and the billing and collection of fees between the caller and receiver. The major system elements consist of database server, multiple subsystems, and multiple users connected over a multi-user electronic network.

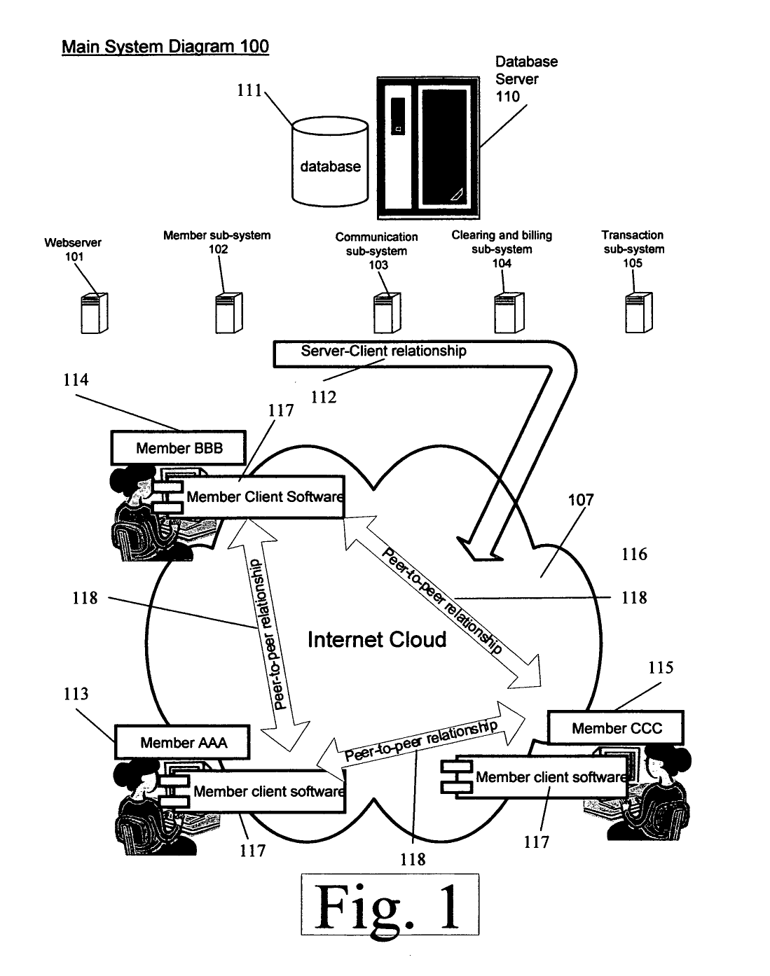

The mechanics of the processes and activities discussed above can be achieved using the conceptual model of FIG. 1. FIG. 1 represents the main system diagram (100) of the present invention. The physical system consists of a database server (110) that contains information in a database (111). The database server (110) also includes a webserver (101) which enables members (113, 114, and 115) to interact with the system software , a member sub-system (102) for processing and storing member information, a communication sub-system (103) that enables members (113, 114, and 115) to interact with each other and engage in multimedia communications, a clearing and billing sub-system (104) that provides for efficient billing, payment, and fund transfer, and a transaction subsystem (105) for enabling, recording, and effectuating online transactions between members and between members and system (113, 114, and 115). The database server (110) and its systems are connected to members via multi-user network, also referred to as an Internet Cloud (107) that establishes a server-client relationship between the database server (110) and members.

Via the Internet Cloud (107) members (113, 114, and 115) downloads and installs client-software (117), and login to the communication sub-system (103) and enter a “stand-by for communication” mode. The client software (117) enables members (113, 114, and 115), via the Internet cloud (107), to communicate directly with other users in a peer-to-peer relationship (118).

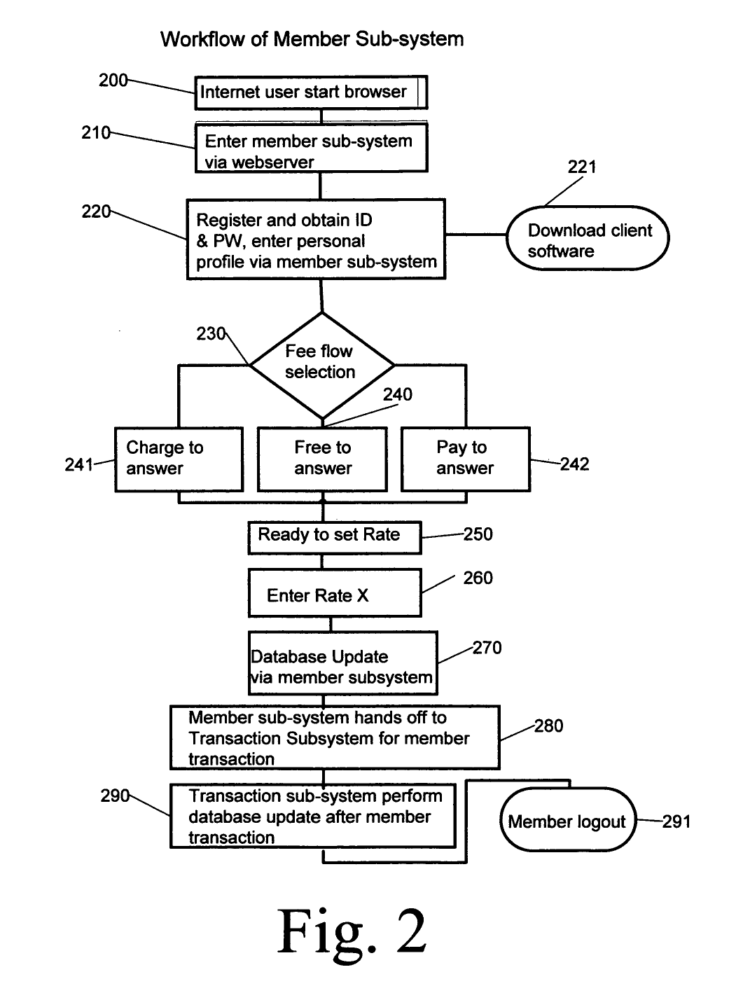

FIG. 2 illustrates the workflow of the member subsystem (102) that a member experiences when first registering for the system or returning to offer or purchase services. In the first step a member starts their Internet browser (200) to access the Internet could (107). Next the member enters the subsystems via the webserver (101). Once a member accesses the webserver (101), they may register and obtain a unique ID, password, and enter personal information (220) via the member subsystem (102). If the member has not downloaded the client software (221), they may do so at this point. Next, each member chooses a fee flow method (230) among options of “Pay-to-Answer (PA)” (242), “Charge-to-Answer (CA) (241)”, and “Free-to-Answer (FA) (240)”. Now the member is ready to set their own per-pulse fee rate (250) and does so by entering their desired rate (260). Once a member enters their desire rate (260), the database (111) is updated (270) via the member subsystem (102). The member subsystem (102) then hands off to the transaction subsystem (105) for process of the member transaction (280). The transaction subsystem (105) performs the database update (290) after the member transaction and the member logs out (291) upon completion.

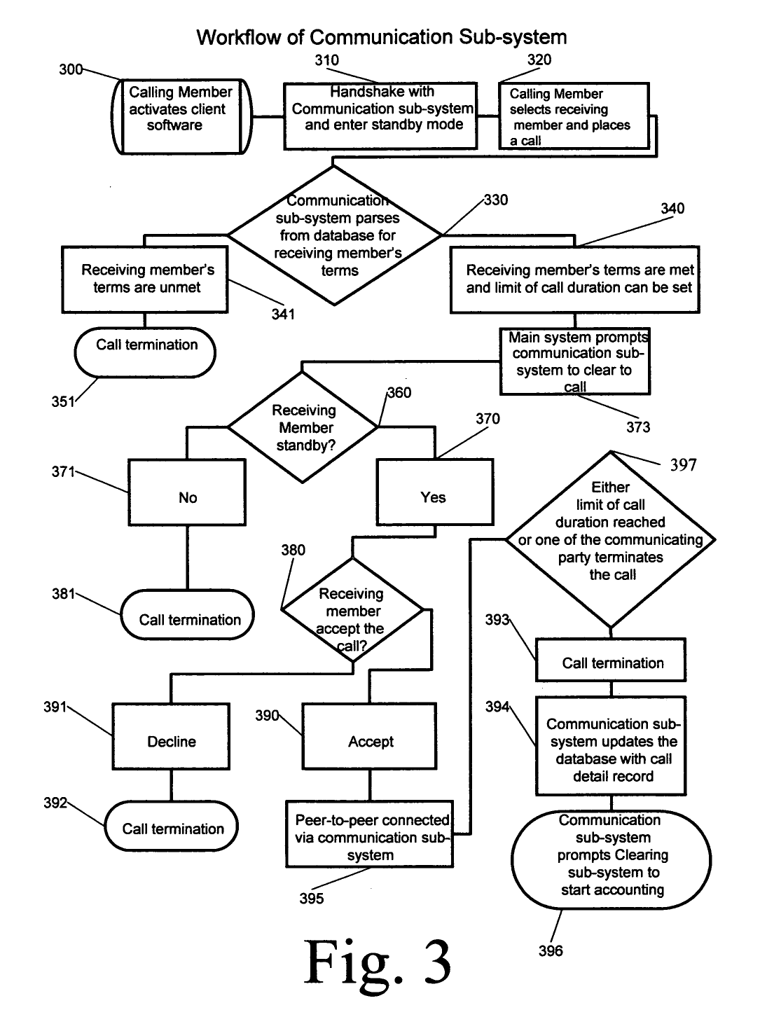

Now referring to FIG. 3 the workflow of the communication subsystem (103) is illustrated. First, the calling member activates the client software (300) and a handshake authentication process activates the communication subsystem (103) and places the system enters into a standby mode (310) waiting the call member's selection. Next the calling member selects a receiving member and places a call (320). The communication subsystem (103) then parses from the database (111) the receiving member's terms and determines whether they are met or unmet (330). If the terms are unmet (341) then the call is terminated (351). If the receiving member's terms are met (340), then a limit on call duration can be set.

The main system on the database server (110) prompts the communication subsystem (103) to clear receivers line to receive call (373). The communication subsystem (103) determines if the receiving member is ready to receive the call (360). If the receiving member is not ready (371) then the call is terminated (381). If the receiving member is ready to receive the call (370) the call is sent and the receiving member must then determine if they want to attempt the call (380). If the receiving member declines (391) the call is terminated (392). If the receiving member accepts (390) the call is connected by the communication subsystem (103) via a peer-to-peer connection (395).

Upon one party terminating the call or the expiration of the call limit duration (397), the call is terminated (393) and the communication subsystem (103) updates the database (111) with call details to create a record (394) and then the communication subsystem prompts the clearing subsystem (104) to start the accounting process (396).

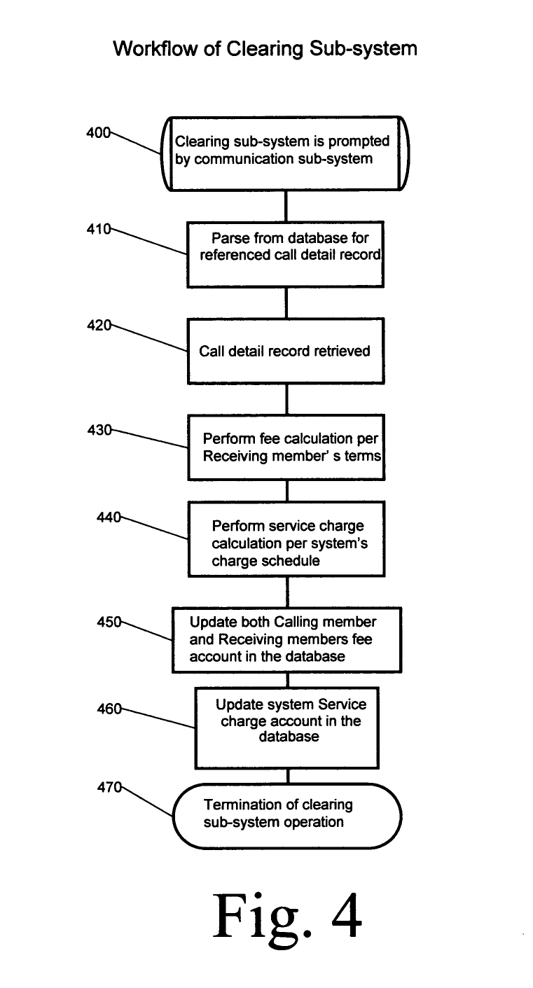

Now referring to FIG. 4 the workflow of the clearing subsystem (104) is illustrated. The clearing subsystem (104) is prompted by the communication subsystem (103) to initiate the process (400). The clearing subsystem (104) then parses from the database (111) to obtain a referenced call detail record (410) and retrieves said call detail record (420). Next the clearing subsystem (104) performs a fee calculation following the receiver member's terms (430) and performs a service charge calculation (440) per system's charge schedule. Then both the calling and receiving member's fee accounts in the database (111) are updated (450), the system's service charge account is updated (460), and the clearing subsystem operation is terminated (470).

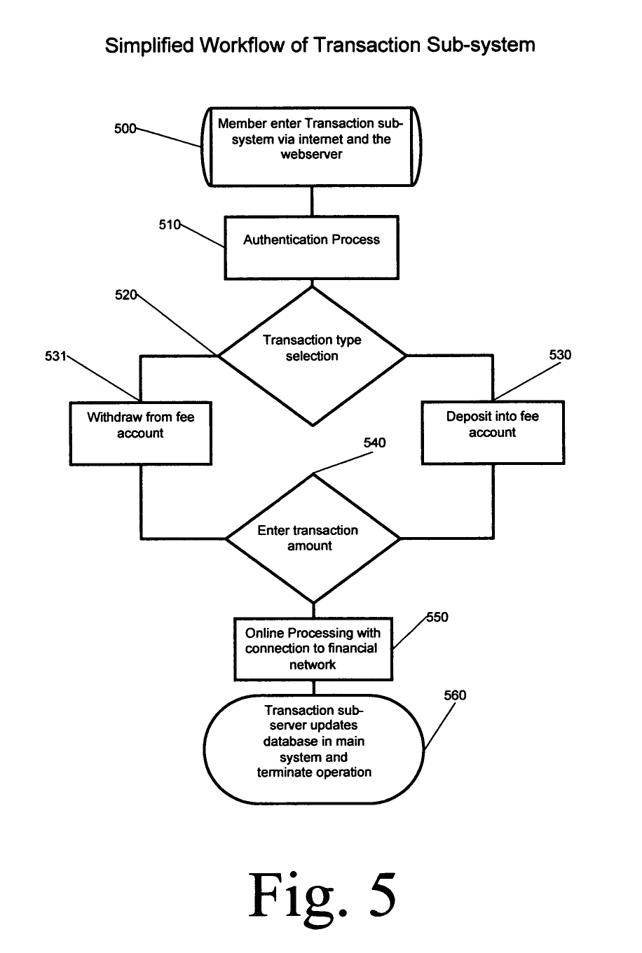

FIG. 5 illustrates the simplified workflow of the transaction subsystem (105). A member enters the transaction subsystem (105) via a multi-user electronic network such as the Internet using the webserver (101) to start the process (500). Next an authentication process occurs (510) and a transaction type is selected by the member (520). The member can either elect to withdraw funds from the fee account (531) or deposit funds into the fee account (530).

Fund amounts for the desired withdraw or deposit is entered (540) and the transaction is processed online in connection with a financial network (550). Finally, the transaction subsystem (105) updates the database (111) and terminates the operation (560).

When receiving a call a member may or may not be required to deposit money into their fee account. Depending on a member's chosen fee scheme, in case of a CA member, the call can be answered without having to deposit a stored value into members fee account, because fee will flow from caller to receiver, and benefit the receiving member. In case of a PA or FA fee flow methods, the member will have to purchase, via transaction sub-system (105), and deposit into the stored-value fee account, in order to fulfill the fee flow paying to the caller and system.

When making a call a member may or may not be required to deposit money into their fee account. Depending on the Called (receiving) member's chosen fee scheme, in case of a PA or FA call, calling member can be cleared for the call, cause the calling party will benefit from the call and there is no need for the caller to pay any fee. In case of a CA call, the calling member will have to purchase via transaction sub-system (105) and deposit into the stored-value fee account, in order to fulfill the fee flow paying to the called (receiving) member and system.

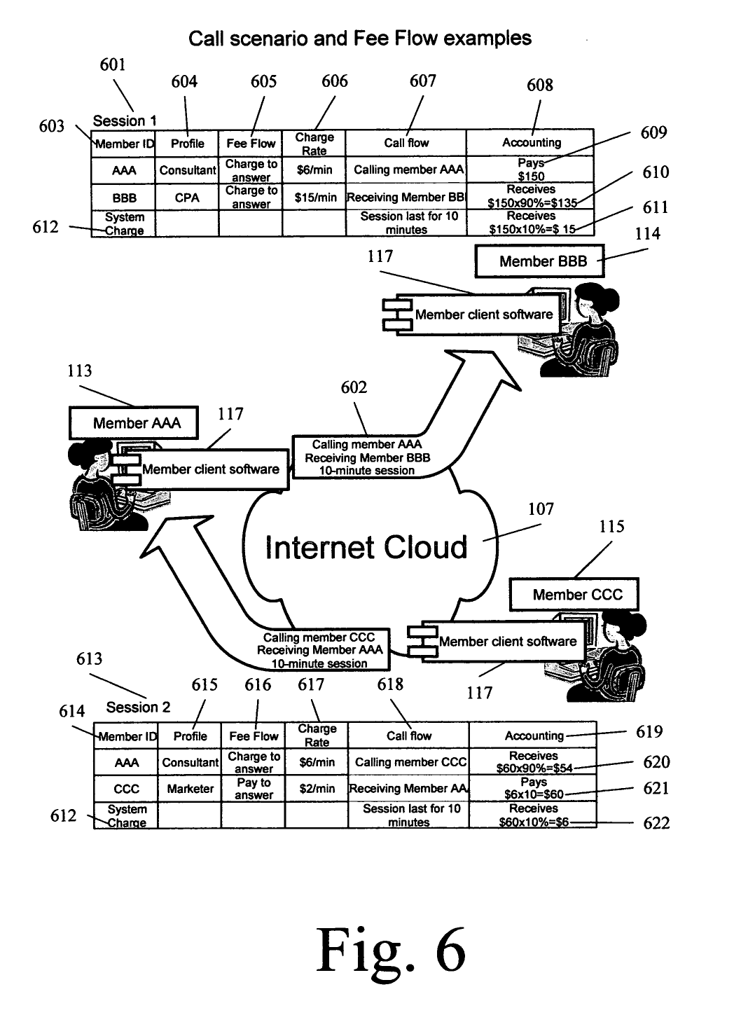

Now referring to FIG. 6 a call scenario and fee flow example is given. Call session 1 (601) Member AAA (113) utilizes the member client software (117) to contact Member BBB (114) through the Internet cloud (107). The member subsystem (102) contains the member IDs (603), profiles (604), fee flow selections (605) and rate information (606). The communication subsystem (103) controls the call flow (607), initiation, duration, and termination. When the call is completed the clearing subsystem (104) performs the calculations to determine the flow of payment and the system charge (608). In session 1 (601) the calling Member AAA (113) initiated a 10-minute session (602) with Member BBB (114). According the member and system rates, this call cost Member AAA (113) $150 (609), with the system taking a 10% system charge (612) of $15 (611) and then passing the remainder of the payment, $135, (610) along to Member BBB (114).

FIG. 6 also illustrates a second session (613) where Member CCC (115) utilizes the member client software (117) to contact Member AAA (113) through the Internet cloud (107). The member subsystem (102) contains the member IDs (614), profiles (615), fee flow selections (616) and rate information (617). The communication subsystem (103) controls the call flow (618), initiation, duration, and termination. When the call is completed the clearing subsystem (104) performs the calculations to determine the flow of payment and the system charge (619). In session 2 (613) the calling Member CCC (115) received a 10-minute session (602) with Member AAA (113). According the member and system rates, this call cost Member CCC (115) $54 (620), with the system taking a 10% system charge (612) of $6 (621) and then passing the remainder of the payment, $60, (622) along to Member AAA (115).

It is appreciated that the relationships for the parts of the invention, to include variation in database and subsystem configuration to detach them for each other and provide the possibilities to deploy the system in different locations and under different authorities with division of labor, are deemed readily apparent and obvious to one of ordinary skill in the art, and all equivalent relationships to those illustrated in the drawings and described in the above description are intended to be encompassed by the present invention.

In addition, other areas of art may benefit from this method and adjustments to the design are anticipated. Thus, the scope of the invention should be determined by the appended claims and their legal equivalents, rather than by the examples given.

1. A system for receiver self-priced multimedia communication comprising:
a main system with a CPU, operation systems, memory modules, database engine, storage medium to interact with all Subsystems and process data generated from all system routines;
a web server with a group of software to provide user interface via a multi-user network;
a client software for members to download and install, to co-work with all sub-systems to facilitate member communications and account management a member subsystem with a group of software, to co-work with all sub-systems and installed member client software, for users to register and become members, for members to perform data manipulation, update and queries.

2. Thee ? system for receiver self-priced multimedia communication of claim 1 comprising a communication subsystem with a group of software, to co-work with all sub-systems and installed member client software, to facilitate member communication over the a multi-user network, to generate and manipulation data relating to communication sessions between members.

3. Thee ? system for receiver self-priced multimedia communication of claims 1 and 2 comprising a clearing and billing sub-system: built with a group of software, to co-work with all sub-systems and installed member client software, to generate and manipulate data for billing and transferring of member's fee records;

4. Thee ? system for receiver self-priced multimedia communication of claims 1, 2, and 3 comprising a transaction subsystem with a group of software, to co-work with all sub-systems and installed member client software, for members to purchase stored value to be deposited into members' fee account, and for transaction related data generation and manipulation;

5. Method for receiver self-priced multimedia communication comprising:
users connect with the system via a multi-user network connected to computers and other mobile electronic devices that utilize browsers, enter member subsystem via a browser page;
one or more users registers as a member with an unique member ID paired with password;
member chooses a fee flow method among options of “Pay-to-Answer (PA)”, “Charge-to-Answer (CA)”, and “Free-to-Answer (FA)”;
member individually sets member's per-pulse fee rate;
members download and install the client software into their connected electronic device;
member purchase via transaction subsystem for stored value and deposit the stored value into members fee account;
member can perform update or alteration of member's fee scheme setting;
member activates the client software and connects to communication subsystem to declare a on-line status and standby for communications;
member can call other online members by members ID;
when a call is placed, communication subsystem will query the database in main system, and retrieve the receiver's fee scheme, determine the fee flow, calculate the maximum call duration per payer's fee account balance and payee's per pulse rate and prompt the receiver for connection;
once the call is accepted by the receiver, both members are connected for a communication session, and communication subsystem starts clocking the time for communication;
when the communication meets the maximum call duration time, or either member engaged in the communication terminates the call;
communication subsystem will break the communication and generate a call record to be written into database, and for the processing of clearing and billing subsystem;
clearing and billing subsystem will retain the call record and calculate per system parameters the applicable fees charges;
clearing and billing subsystem will transfer applicable fee charges out of payer's fee account and distribute into the accounts of payee and system and update the database.

6. The method of claim 5 wherein said fee denominator is a virtual token, and not limited to real money, an exchange rate between real money and the virtual token will be contained in the database as system parameter for calculation of fees.

7. The method as in claims 5 and 6, wherein said connected PC or electronic device is to be any of the following: a multi-user network connected to a mobile phone, a multi-user network connected personal data assistant (PDA), a multi-user network connected to intelligent appliances, a multi-user network Connected Audio/Video device, a multi-user network connected public phone, a multi-user network connected vending machine, a multi-user network connected Kiosk.

8. The method as in claims 5, 6, and 7 wherein said fee scheme is to be a matrix system sensitive to time, where fee flow and rate are set to be different in different time slots divided by hour of the day, day of the week, or day of the month.

9. The method as in claims 5, 6, 7, and 8 wherein said declaration of online status of the said member is to be further published via web pages and accompanied with a hyperlink, with the click of said hyperlink, a call can be placed for connecting the said member, and the said member is identified as the Receiver and said members fee scheme prevail.

10. The method as in claims 5, 6, 7, 8 and 9 wherein said called member is to be more than one member, and result in a one-to-many conference session.

11. The method as in claim 5, 6, 7, 8, 9 and 10 wherein said calls is to be placed by entering an URL from the browser.

12. The method as in claim 10 wherein said call is to be placed by entering an URL from the browser, and the said URL is pre-configured to connect for a one-to-many conference session.

13. The method as in claims 11 and 12 wherein said URL is to be entered via a voice recognition system for voice commands.

14. The method as in claims 11 and 12 wherein said URL is to be entered via a pattern recognition system for handwritings.

15. A system and method for receiver self-price multimedia communication comprising:
a main system with a CPU;
a web server with a group of software to provide user interface via a multi-user network;
a member subsystem with a group of software;
a communication subsystem to facilitate member communication over the a multi-user network and to generate and manipulation data relating to communication sessions between members;
a clearing and billing sub-system to generate and manipulate data for billing and transferring of member's fee records;
a transaction subsystem with a group of software for members to purchase stored value to be deposited into members' fee account, and for transaction related data generation and manipulation;
client software for members to download and install to facilitate member communications and account management;
one or more users connected with the system via a multi-user network connected to computers and other mobile electronic devices that utilize browsers;
member chooses a fee flow method among one or more payment options;
member sets member's per-pulse fee rate;
member downloads and installs the client software into their connected electronic device;
member purchase via transaction subsystem for stored value and deposit the stored value into members fee account;
members can perform update or alteration of member's fee scheme setting;
members activate the client software and connect to communication subsystem to declare a on-line status and standby for communications;
when a call is placed, communication subsystem will query the database in main system, and retrieve the receiver's fee scheme, determine the fee flow, calculate the maximum call duration per payer's fee account balance and payee's per pulse rate and prompt the receiver for connection;
once the call is accepted by the receiver, both members are connected for a communication session, and communication subsystem starts clock the time for communication;
when the communication meets the maximum call duration time, or either member engaged in the communication terminates the call;
communication subsystem will break the communication and generate a call record to be written into database;
clearing and billing subsystem will retain the call record and calculate per system parameters the applicable fees charges;
clearing and billing subsystem will transfer applicable fee charges out of payer's fee account and distribute into the accounts of payee and system and update the database.

16. The method of claim 15 wherein said fee denominator is a virtual token, and not limited to real money, an exchange rate between real money and the virtual token will be contained in the database as system parameter for calculation of fees.
